(19) United States
(12) Patent Application Publication
(10) Pub. No.: US 2024/0168901 A1
(43) Pub. Date: May 23, 2024

(54) SYSTEMS AND METHODS FOR MANAGING INFORMATION ACROSS MULTIPLE APPLICATIONS

(71) Applicant: Doug Bass, Pasadena, CA (US)

(72) Inventor: Doug Bass, Pasadena, CA (US)

(73) Assignee: ConnectALL, LLC, Pasadena, CA (US)

(21) Appl. No.: 17/989,446

(22) Filed: Nov. 17, 2022

(51) Int. Cl. G06F 13/38

(52) U.S. Cl. CPC G06F 13/382

(57) ABSTRACT

A system for configuring universal adapters and application links for managing information across multiple applications is disclosed, including at least one user computing device in operable connection with a network. At least one application link in operable communication with the network, the at least one application link to manage a mapping user interface. A system administrator to upload and install application logos, application attributes, API endpoints, and Tx scripts each transmitted to a universal adapter descriptor repository.

### TECHNICAL FIELD

The embodiments generally relate to computerized systems for the managing information across multiple applications.

### BACKGROUND

Advances in computer technologies has led to an abundance of applications used to perform various tasks and provide convenience to their users. However, many applications are unable to communicate with one another, leaving disparate information spread across platforms. Synchronizing records has historically been performed manually, costing resources and leaving the potential for human error.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein describe a system for configuring universal adapters and application links for managing information across multiple applications. At least one user computing device in operable connection with a network. At least one application link is in operable communication with the network. At least one application link manages a mapping user interface. A UA descriptor factory creates an application adapter to operate an application adapter instance to sync data with at least one application. A universal adapter descriptor includes one or more application logos, one or more application attributes, one or more API endpoints, and one or more Tx scripts. A system administrator to upload and install application logos, application attributes, API endpoints, and Tx scripts each transmitted to a universal adapter descriptor repository.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of a computing system, according to some embodiments;

FIG. 2 illustrates a flowchart of the process for managing information across multiple platforms;

FIG. 3 illustrates a block diagram of the universal adapter descriptors, according to some embodiments; and

FIG. 4 illustrates a block diagram of the universal adapter descriptors, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments provide systems and methods for managing information across multiple platforms. An external application provided API may be suitable when the desired application to be integrated provides a ReST API that the system can use for querying/polling for changes to objects and entities, to read records/objects/entities from the other application, to put new records to the application, and to put changes to records back to the application. To adopt this approach, the application's API and data transformations are specified using the system's configuration interface. Once configured, the system will poll a second application using it's ReST API.

Universal adapters can be created and configured directly through the user interface, or by manually crafting a universal adapter descriptor.

To create a universal adapter, the universal adapter is named and specified using an application type which is the type specified when the user requests the universal adapter license. An icon is provided to be used within the system to represent the application. The fields the application uses are specified and the applications metadata (e.g., entity types and projects are specified. Further, schemes which specify how to transform messages between your end application's API and the system API is specified. Schemes are associated with application links via the metadata which is specified in both the scheme and the application link. To use a universal adapter, a connection is created, and the connection is used in an application link.

To synchronize data with an application, the system needs to know about the fields that need to be synchronized, and any metadata required by the application. Examples of metadata for an application are project and issue type (or entity type). Those are two common pieces of metadata, but not all applications require those, and some require other pieces of information.

When configuring an application link, metadata is the information that you will see in the Entity Mapping interface. When configuring an application link, the user interface presents various information from the UA metadata.

Metadata also is also how you form a relationship between different schemes and application links. For example, the user may have issue-type metadata. There may be two issue types: Bugs and Stories. Further, the user may need to specify an API for each issue type, such as one for Bugs and another for Stories. In another case, the user may need a slightly different transformation specification for each issue type. In another case, the user may have one scheme for Bugs and another for Stories. Likewise, you might have one applink for Bugs (and bug-specific fields) and another applink for Stories (and story-specific fields). That piece of metadata for issue-type (Bugs vs Stories) ties the scheme to the application link.

The ReST API specifies how the systems communicate with other applications. Schemes translate this API into the end application's API while translating both the requests and the responses. API configuration is mandatory for the synchronization of records when you are using an External API provider. The API configuration, or schemes can be configured at an adapter level and also at the metadata level for synchronization.

To configure an API, the user selects universal adapters from a list and a universal adapter configuration page is displayed. The user navigates the user interface, selecting to view the API configuration interface and then selecting to add a scheme to allow the user to select a preexisting scheme or to select a new scheme. A new scheme name is then entered. The API configuration screen allows the user to make selections including ReST API configuration, Request Headers, and Metadata Association.

The ReST API configuration section has the list of APIs supported by the system for the external API provider. The list of APIs supported comprise: Query Modified records, Ready Record by ID, Create Record, and Update Record. The following parameters are configured for each API: URL—ReST API URL for the operation; HTTP Verb—for the operation (options include GET, POST, PUT, and PATCH); Request Spec Configuration—Request transformation specification for the operation; and Response Specification Configuration—Response transformation specification for the operation.

API URLs and URL field options can be selected to add fields to the URL as a convenience mechanism. The user may add ValueSeparator and FieldSeparator values to have the appropriate separators matching the API.

During Transformation Specification Configuration, the ability to send a Request Body is available only Create Record and Update Record functions. The selection box may be cleared when the operation doesn't have any request payload required for the adapter. Further, it can be used in conjunction when the payload has to be sent in the URL instead of the request body. The system expects a response body in response to API calls, but for Update Record, the response body is optional. For Update Record response specifications, the check box can be cleared when the operation doesn't have any response payload available from the adapter.

Some ReST APIs require values to be sent in the “request header”. In this section, the user may configure any request header to be sent for all the APIs configured in the current scheme.

The user may configure the specific metadata for a scheme or make it as Default for all metadata by clicking the Default option.

In some embodiments, a scheme can be configured in the Draft or in the Active state by clicking Save As Draft or Activate buttons respectively. Note that the adapter should have at least one default scheme and can have ‘n’ number of the overridden schemes. If there are overridden schemes configured while synchronizing, the application will compare the metadata configured with the overridden schemes and apply the scheme. If the metadata information is not matching, the Default scheme will be applied.

The system allows you to test the configuration of an external application API. The test configuration option is available for Query Modified Record, Record by ID, Create Record and Update Record operations. To test the configuration of a scheme, it should be associated with an app-link. To test a configuration, the user clicks the Configure link against the API Configuration option and the API configuration screen is displayed. The user then clicks the test configuration icon displayed against an API and the Input screen will display the Application Link drop-down list. An app-link is selected along with the Test Configuration option. Once the testing is complete, the Response Payload section will display the results. Depending upon the API you choose to test the configuration, the fields will be displayed in the Test API Configuration screen. Suppose if you click the Test Configuration button against the Query Modified records API, the date fields will be displayed for you to select a date range as displayed below. select the date range and click Test Configuration.

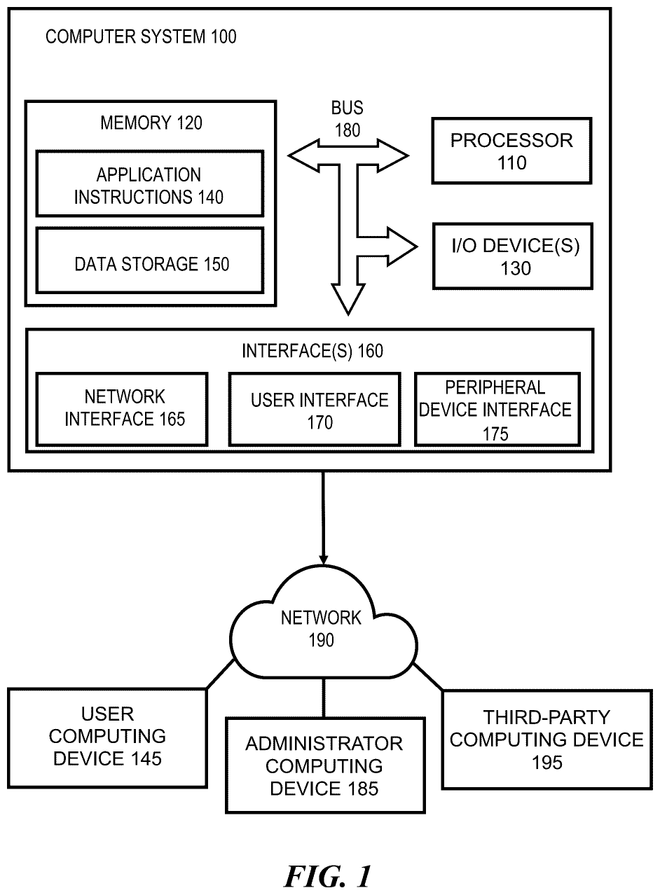

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized to establish credentials, create a user profile, and otherwise interact with the community management system. The third-party computing device 195 may be utilized by third parties (e.g., a service provider) to receive communications from the user computing device and/or administrative computing device 185.

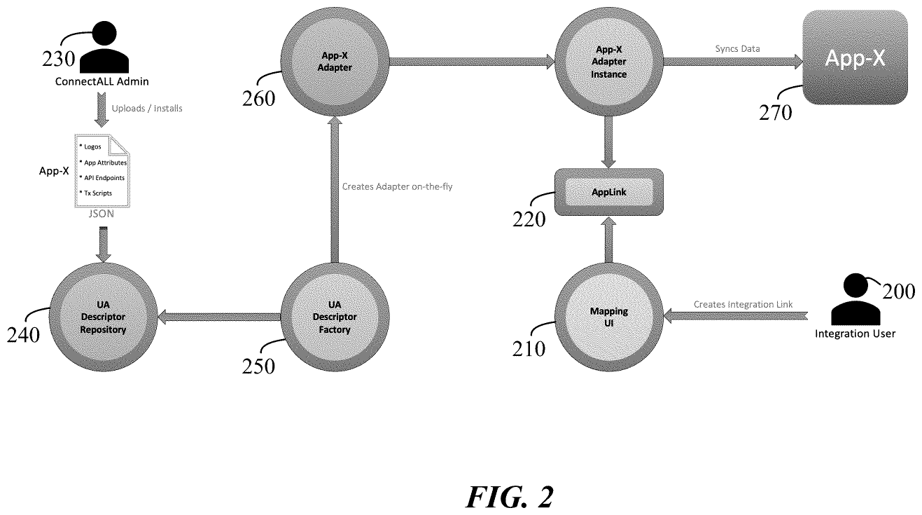

FIG. 2 illustrates a flowchart for a process of configuring universal adapters and application links for managing information across multiple applications. A system administrator 230 uploads and installs application logos, application attributes, API endpoints, and Tx Scripts which are each transmitted to a universal adapter (UA) descriptor repository 240. The user 200 creates an application link using the mapping user interface 210 in communication with the application link 220. A UA descriptor factory 250 is in communication with the UA descriptor repository 240. The UA descriptor factory 250 creates an application adapter 260 which operates an application adapter instance 260 which syncs data with the application 270.

In some embodiments, first a system administrator 230 uploads an application logo, application attributes (a list of fields and their values that are needed to use the application's API), API endpoints, and Transformation (Tx) Scripts, which collectively comprise the universal adapter descriptor. This descriptor is transmitted to a universal adapter (UA) descriptor repository 240.

A UA descriptor factory 250 is in communication with the UA descriptor repository 240. The UA descriptor factory notices a new or updated descriptor, retrieves the new or updated descriptor, and uses the information contained therein to construct an Adapter capable of communicating with the desired end application via the specification described in the descriptor.

The application logo will be used in the Mapping UI to help the Integration User identify which application is betting represented in the UI on each side of the mappings, described below. The API endpoints specified in the UA Descriptor will be used by the Adapter Instance to communicate with the end application.

Later, an Integration User will use the Mapping UI to create an instance of the aforementioned constructed Adapter. This instance holds the base URL of the end application along with authentication/authorization credentials. This is termed a “Connection” to an end application. Next, the Integration User uses the Mapping UI to create an “application link” (or “AppLink”) between two end applications. This is done by specifying which Adapter Instances should be used along with a mapping between each application's fields and, optionally, values for those fields. For example, one application's Summary field may be mapped to another application's Title field; their Description fields will be mapped together; and one's Status field will be mapped to the other's State field. For the State field's value mappings, continuing with the example, one application's “New” Status will be mapped to the other application's “To Do” State.

Finally, now that the system is all set up, the system uses each adapter instance's connection information and each application's API (as specified in the descriptor) to retrieve changed records and fields from the respective end applications and sync new values from them to the other end application using the mappings in the application link.

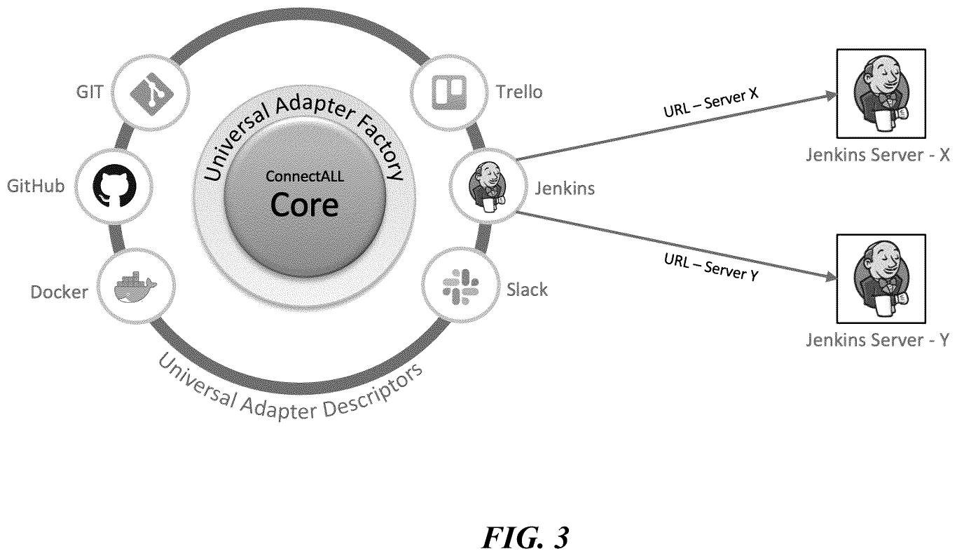

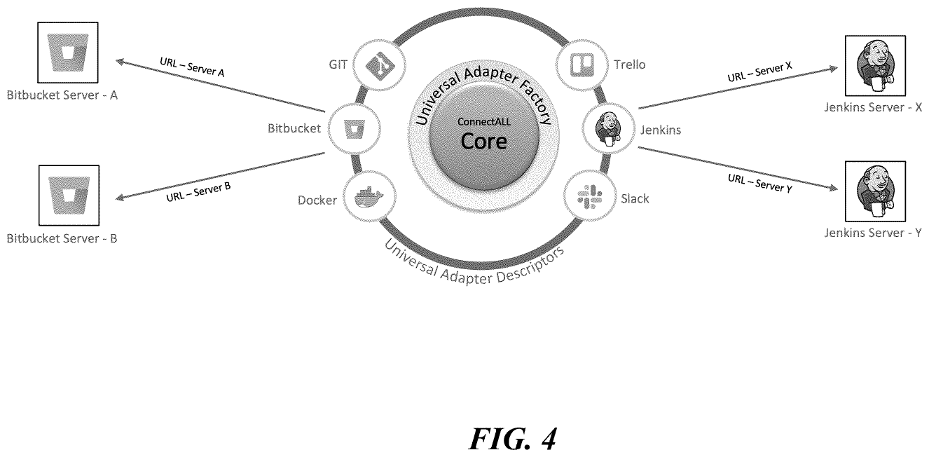

FIGS. 3-4 illustrate block diagrams of the system for managing information across multiple platforms. In reference to FIG. 3, universal adapter descriptors have been created or uploaded for six end applications: Docker GitHub, Git, Trello, Jenkins, Slack. One skilled in the arts will readily understand that additional end applications may be utilized. The universal adapter factory has created adapters for each of those applications. And an Integration laser has created two Adapter instances via the process of creating application links. The user created an Adapter Instance for “Jenkins Server—X” and “Jenkins Server—Y”. The Adapter Instances will communicate with the end applications with their respective URLs. FIG. 4 expounds on FIG. 3 to illustrate an additional Adapter created for the application BitBucket, and two adapter instances for “BitBucket Server—A” and “BitBucket Server—B”.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for configuring universal adapters and application links for managing information across multiple applications, comprising:
at least one user computing device in operable connection with a network;
at least one application link in operable communication with the network;
at least one application link to manage a mapping user interface;
a UA descriptor factory to create an application adapter to operate an application adapter instance to sync data with at least one application;
a universal adapter descriptor comprising one or more application logos, one or more application attributes, one or more API endpoints, and one or more Tx scripts;
and a system administrator to upload and install application logos, application attributes, API endpoints, and Tx scripts each transmitted to a universal adapter descriptor repository.

2. The system of claim 1, wherein the universal adapter descriptor specifies a means for communicating with one or more third-party applications.

3. The system of claim 1, further comprising a UA descriptor factory.

4. The system of claim 2, wherein the UA descriptor factory is in communication with the UA descriptor repository.

5. The system of claim 4, wherein the application logos, application attributes, API endpoints, and Tx scripts comprise the universal adapter descriptor.

6. The system of claim 5, wherein the UA descriptor factory notices a new UA descriptor or an updated UA descriptor and retrieves the new UA descriptor or the updated UA descriptor to construct an UA capable of communicating with at least one end application.
